(19) United States
(12) Patent Application Publication
(10) Pub. No.: US 2009/0269155 A1
(43) Pub. Date: Oct. 29, 2009

(54) Alignment Structure for a Wood Flat Drill Bit

(76) Inventor: Eupin WANG, Taipei County (TW)

Correspondence Address: Dr. BANGER SHIA, 102 Lindencrest Ct., Sugar Land, TX, 77479-5201, US

(21) Appl. No.: 12/110,908

(22) Filed: Apr. 28, 2008

(51) Int. Cl. B23B 51/00

(52) U.S. Cl. 408/211

(57) ABSTRACT

An alignment structure for a wood flat drill bit comprises a flat drill bit and a connecting assembly. The drill bit has a flat drilling end and the other end of the drill bit is provided for positioning the connecting assembly. The connecting assembly and the flat drill bit are formed with conical portions for abutting against each other. Hence, the flat drill bit can be automatically aligned by abutting the conical portion of the flat drill bit against that of the connecting assembly.

### BACKGROUND OF THE INVENTION

1. Field of the Invention

The present invention relates to an alignment structure for a wood flat drill bit, and more particularly to a wood flat drill bit which is quickly replaceable and can be automatically aligned.

2. Description of the Prior Art

Conventionally, woods should be subjected to scraping, smoothing, sawing, chiseling, drilling and the like processes first, and then are assembled to form a desired structure. However, not any metalworking drill bit except those specially designed for woodworking can be used to process wood due to the special grain arrangement of the wood, especially in a hole drilling operation, a wood flat drill bit must be used. The working flat chisel has a cutting portion and a central cuspidal guiding portion formed in the front end thereof. At both ends of the cutting portion are formed a cone-shaped sharp edge for cutting the wood grain, and the cuspidal guiding portion in the center of the frond end is used to position the chisel. During hole drilling operation, the central cuspidal guiding portion is used to drill a small cavity first in the wood to be operated, then the cone-shaped sharp edges at both sides of the cutting portion cut the grains of the wood surface, and finally the cutting portion carries out the cutting and drilling operation so as to drill a hole in the wood. However, such a conventional wood flat drill bit has the following disadvantages:

First, such a wood flat drill bit can only drill one size of hole, and it should use another drill bit if another size hole needs to be drilled, thus causing inconvenience in replacing the drill bit.

Second, when other types of drill bits (such as screwdriver bit, grinding tools) need to be used, it will also cause inconveniences since it has to remove the wood drill bit from the power tool and assemble the desired bit on it).

Third, the conventional wood flat drill bit is usually long in order to drill different depth holes, however, in addition to the disadvantages of occupying a relatively large space and being inconvenient to use due to its relatively long length, such a wood flat drill bit cannot be extended in length because it is a integrally formed structure, in other words, such a conventional wood flat drill bit is not adjustable in hole drilling depth capability.

Fourth, the excessive long length makes the conventional wood flat drill bit more susceptible to vibration during hole drilling operation, further, the wood flat drill bit must be aligned properly when being assembled to or removed from a power tool, and the alignment operation is very time consuming.

The present invention has arisen to mitigate and/or obviate the afore-described disadvantages.

### SUMMARY OF THE INVENTION

The primary objective of the present invention is to provide an alignment structure for a wood flat drill bit which enables the wood flat drill bit to be automatically aligned after it is assembled to a power tool.

To achieve the above objective, the alignment structure for a wood flat drill bit in accordance with the present invention is designed to have a flat drill bit and a connecting assembly. The drill bit has a flat drilling end and the other end of the drill bit is provided for positioning the connecting assembly. The connecting assembly and the flat drill bit are formed with conical portions for abutting against each other. Hence, the flat drill bit can be automatically aligned by abutting the conical portion of the flat drill bit against that of the connecting assembly.

With such arrangement, in addition to the fact that the connecting assembly fixed on the power tool enables a quick replacement of the wood flat drill bit, and more important, the wood flat drill bit can be automatically aligned when it is assembled to the power tool.

Another objective of the present invention is to provide an alignment structure for a wood flat drill bit which can be extended and shortened.

To achieve this objective, the connecting assembly of the present invention is detachably positioned in the recess of the flat drill bit by a steel ball. The connecting assembly allows for easy and quick replacement of the flat drill bit. Since the connecting assembly itself has a certain length, it can cooperate with various length drill bits to drill different depth or sized holes (deeper holes).

In addition to the above-mentioned characteristics, another important design of the present invention is that the connecting assembly and the flat drill bit are formed with conical portions for abutting against each other. Hence, the flat drill bit can be automatically aligned by abutting the conical portion of the flat drill bit against that of the connecting assembly. Other variations of designs similar to the conical portion or position changes should also be considered within the scope of the present invention.

### BRIEF DESCRIPTION OF THE DRAWINGS

FIG. 1 is an exploded view of an alignment structure for a wood flat drill bit in accordance with a first embodiment of the present invention;

FIG. 2 is a cross sectional view of the alignment structure for a wood flat drill bit in accordance with the first embodiment of the present invention;

FIG. 3 is an operational view of the alignment structure for a wood flat drill bit in accordance with the first embodiment of the present invention;

FIG. 4 is an exploded view of a part of an alignment structure for a wood flat drill bit in accordance with a second embodiment of the present invention; and

FIG. 5 is an operational view of the alignment structure for a wood flat drill bit in accordance with the second embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

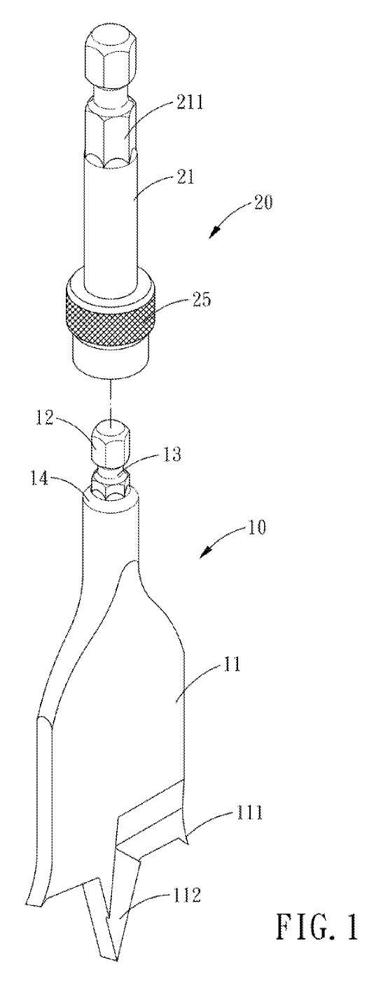

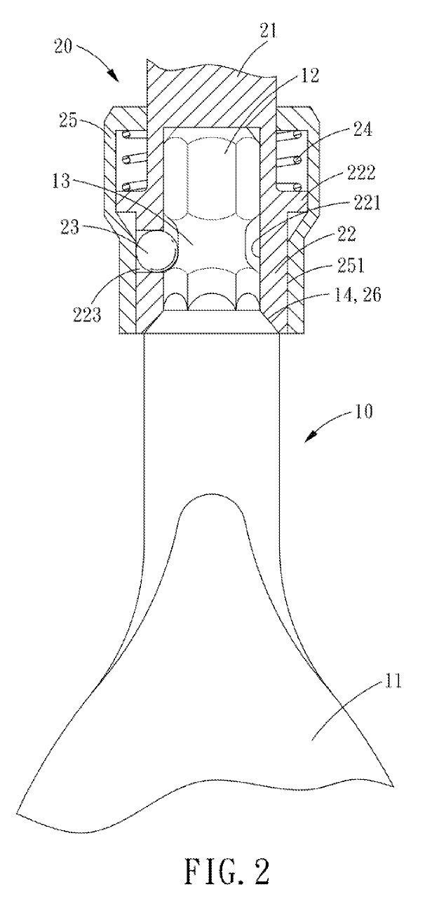

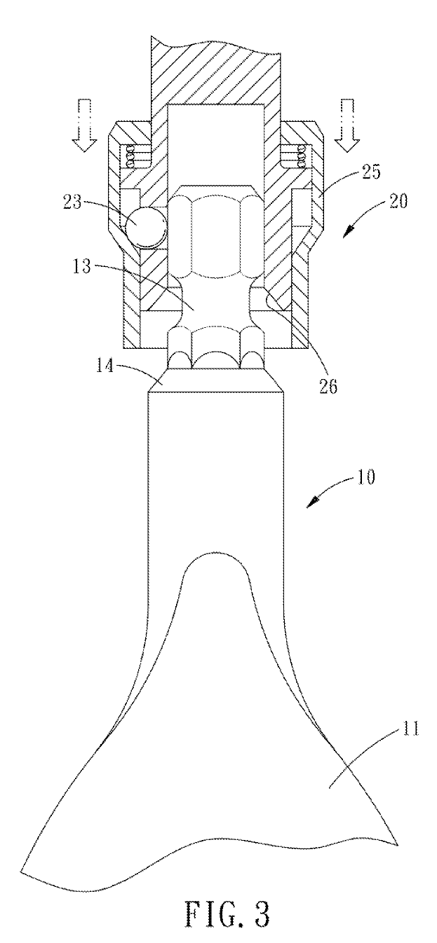

Referring to FIGS. 1-3, an alignment structure for a wood flat drill bit in accordance with the present invention is to be driven to rotate by a power tool and comprises: a flat drill bit 10 and a connecting assembly 20.

The flat drill bit 10 is a unitary structure having a flat drilling end 11 and an angular end 12. The flat drilling end 11 has two protruding cutting edge at both sides thereof and a central guiding edge 112. The angular end 12 is hexagonal in cross section, in the middle of the angular end 12 is defined an annular groove 13, and between the flat drilling end 11 and the angular end 12 is defined an outwardly slanted conical portion 14.

The connecting assembly 20 includes a connecting rod 21, a seat 22, a steel ball 23, a spring 24 and a sleeve 25. The connecting rod 21 has an angular end 211, and another end of the connecting rod 21 is fixed to one end of the seat 22. The other end of the seat 22 is defined with a recess 221 for insertion of the angular end 12 of the flat drill bit 10, and around the outer periphery of the recess 221 is formed an annular flange 222. In the outer periphery of the recess 221 is further defined at least one opening 223 which opens outward and is located corresponding to the groove 13 of the flat drill bit 10. The steel ball 23 is movably received in the opening 223, the sleeve 25 is positioned on the seat 22, and the spring 24 is biased between the annular flange 222 and an inner edge of one end of the sleeve 25. A pushing portion 251 for pushing the steel ball 23 is formed on the inner surface of the sleeve 25 and located corresponding to the opening 223. Further, an inwardly slanted conical portion 26 is formed on the edge of the open end of the recess 221 of the seat 22 for abutting against the conical portion 14 of the flat drill bit 10.

For a better understanding of the present invention, its operation and function, reference should be made to the respective drawings again.

With the cooperation of the seat 22, the steel ball 23, spring 24 and sleeve 25 of the connecting assembly 20, the flat drill bit 10 can be locked or removed freely. Further, the insertion of the angular end 12 into the recess 221 can prevent the rotation of the flat drill bit 10. Hence, after one end of the connecting rod 21 of the connecting assembled 20 is assembled to a power tool, the user can replace different types of flat drill bits 10 directly through the recess 221 without removing the connecting assembly 20 from the power tool.

The key characteristics of the present invention are that: while using the recess 221 of the connecting assembly 20 to position the flat drill bit 10, the present invention also takes advantage of the conical portion 26 of the recess 221 to abut against the conical portion 14 of the flat drill bit 10. Hence, the flat drill bit 10 can be automatically aligned by abutting the conical portion 14 of the flat drill bit 10 against the conical portion 26 of the connecting assembly 20.

It is to be noted that the connecting rod 21 of the connecting assembly 20 provides a first allowable depth (which means that the connecting rod 21 lengthens the length of the flat drill bits), therefore, the present invention can use a relative short drill bit 10 to drill a normal hole, in other words, the drill bit 10 of the present invention can be short in length and accordingly easy for storage. In addition, the connecting rod 21 can also cooperate with various length drill bits 10 to meet the demand of drilling different depth or sized holes (deeper holes).

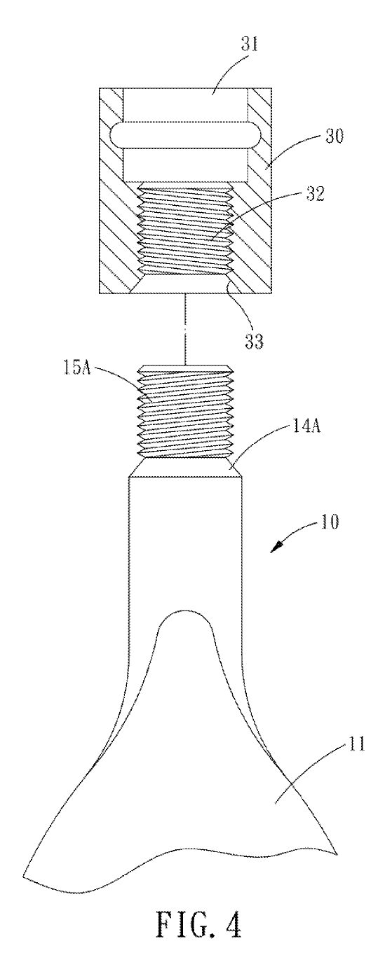

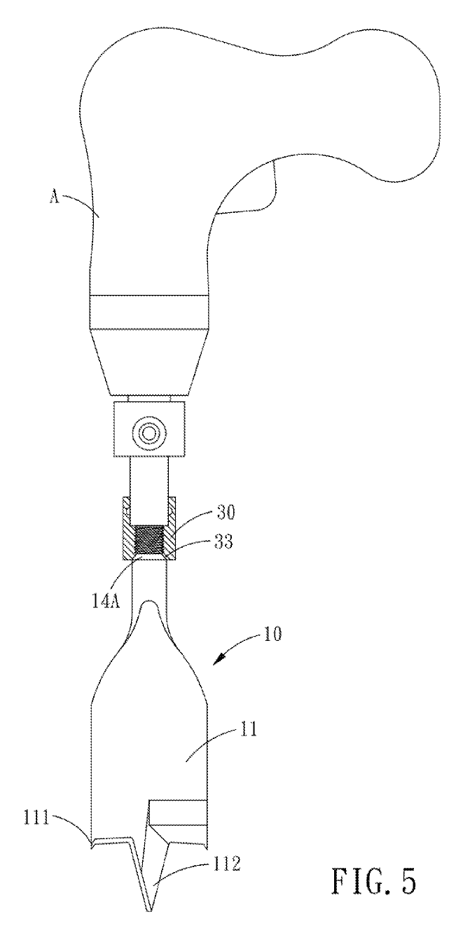

FIGS. 4 and 5 show another embodiment of an alignment structure for a wood flat drill bit in accordance with the present invention, which is also driven to rotate by a power tool and comprises: a flat drill bit 10 and a connecting assembly 30.

The wood flat drill bit 10 is a unitary structure having a flat drilling end 11 and a threaded end 15A. The flat drilling end 11 has two protruding cutting edge at both sides thereof and a central guiding edge 112, and between the flat drilling end 11 and the threaded end 15A is defined an outwardly slanted conical portion 14A.

The connecting assembly 30 has a positioning recess 31 formed at one end and a threaded recess 32 defined at the other end thereof for engagement of the threaded end 15A of the flat drill bit 10. An inwardly slanted conical portion 33 is formed on the edge of the open end of the threaded recess 32 for abutting against the conical portion 14A of the flat drill bit 10.

This embodiment of the alignment structure for a wood flat drill bit still provides the same effect as the previous embodiment: while using the threaded recess 32 to position the flat drill bit 10, the present invention also takes advantage of the conical portion 33 of the threaded recess 32 to abut against the conical portion 14A of the flat drill bit 10. Hence, the flat drill bit 10 can be automatically aligned by abutting the conical portion 14A of the flat drill bit 10 against the conical portion 26 of the connecting assembly 30.

To summarize, the alignment structure for a wood flat drill bit in accordance with the present invention comprises a flat drill bit and a connecting assembly. The drill bit has a flat drilling end and the other end of the drill bit is provided for positioning the connecting assembly. The connecting assembly and the flat drill bit are formed with conical portions for abutting against each other. Hence, the flat drill bit can be automatically aligned by abutting the conical portion of the flat drill bit against that of the connecting assembly.

While we have shown and described various embodiments in accordance with the present invention, it is clear to those skilled in the art that further embodiments may be made without departing from the scope of the present invention.

What is claimed is:

1. An alignment structure for a wood flat drill bit comprising: a flat drill bit and a connecting assembly; wherein:
the flat drill bit has a flat drilling end and an outwardly slanted conical portion; and
one end of the connecting assembly is positioned in another end of the flat drill bit, the connecting assembly has an inwardly slanted conical portion for abutting against the conical portion of the flat drill bit, so that the flat drill bit is automatically aligned by abutting the conical portion of the flat drill bit against that of the connecting assembly.

2. The alignment structure for a wood flat drill bit as claimed in claim 1, wherein:
the flat drill bit is a unitary structure and further has an angular end, and in a middle of the angular end is defined an annular groove;
the connecting assembly includes a connecting rod, a seat, a steel ball, a spring and a sleeve, the connecting rod has an angular end, and another end of the connecting rod is fixed to one end of the seat, the other end of the seat is defined with a recess for insertion of the angular end of the flat drill bit, and around an outer periphery of the recess is formed an annular flange, in the outer periphery of the recess is further defined at least one opening which opens outward and is located corresponding to the annular groove of the flat drill bit, the steel ball is movably received in the opening, the sleeve is positioned on the seat, and the spring is biased between the annular flange and an inner edge of one end of the sleeve, a pushing portion for pushing the steel ball is formed on an inner surface of the sleeve and located corresponding to the opening.

3. The alignment structure for a wood flat drill bit as claimed in claim 2, wherein the flat drilling end of the flat drill bit is formed with two protruding cutting edge at both sides thereof and a central guiding edge.

4. The alignment structure for a wood flat drill bit as claimed in claim 1, wherein:
the wood flat drill bit is a unitary structure and further has a threaded end, and between the flat drilling end and the threaded end is defined an outwardly slanted conical portion;
the connecting assembly has a threaded recess defined at one end thereof for engagement of the threaded end of the flat drill bit, an inwardly slanted conical portion is formed on an edge of an open end of the threaded recess for abutting against the conical portion of the flat drill bit, so that the flat drill bit is automatically aligned by abutting the conical portion of the flat drill bit against that of the connecting assembly.

5. The alignment structure for a wood flat drill bit as claimed in claim 4, wherein the flat drilling end of the flat drill bit is formed with two protruding cutting edge at both sides thereof and a central guiding edge.
